(19) United States
(12) Patent Application Publication
(10) Pub. No.: US 2015/0223157 A1
(43) Pub. Date: Aug. 6, 2015

(54) SEAMLESS CONNECTIVITY ACROSS DEVICES WITH HETEROGENEOUS TRANSPORTS

(71) Applicant: INTEL CORPORATION, Santa Clara, CA (US)

(72) Inventors: Abhirup Ghosh, Bishnupur (IN); Kaustav Dey Biswas, Bangalore (IN); Piyush Joshi, Bangalore (IN)

(21) Appl. No.: 14/126,738

(22) PCT Filed: Jun. 28, 2013
(86) PCT No.: PCT/US13/48715

§ 371 Date: Dec. 16, 2013

(51) Int. Cl. H04W 48/18; H04W 88/10

(52) U.S. Cl. CPC H04W 48/18; H04W 88/10

(57) ABSTRACT

A transport mechanism-agnostic communication system is described. The system may include a plurality of electronic devices, each configured with at least one transport mechanism, and at least one electronic device being configured with two or more heterogeneous transport mechanisms. The at least one electronic device is capable of communicating with each of the plurality of electronic devices and may include a processor, in communication with a memory, configured to execute instructions to translate and route data packets received from a first electronic device over a first transport to a second electronic device over a second heterogeneous transport, wherein the first electronic device can communicate with the second electronic device via the at least one electronic device.

### TECHNICAL FIELD

This disclosure relates generally to the field of electrical communications, and in particular, to multi-transport communication systems and methods.

### BACKGROUND ART

Most of the computing and embedded devices are enabled with some communication medium. However, in some instances, different electronic devices in a particular area may not be able to communicate with each other directly because they may not have a common communication medium available to them. For example, a desktop personal computer (PC) without a wireless radio cannot communicate directly with a smartphone due to lack of common communication medium. As such, a system for allowing communication between various electronic devices regardless of specific communication technologies available to individual electronic devices is required.

### BRIEF DESCRIPTION OF THE DRAWINGS

FIG. 1 depicts an example of a multi-transport access point (MTAP) in accordance with various aspects and principles of the present disclosure.

FIG. 2 depicts management of data transport between two devices via MTAP, in accordance with various aspects and principles of the present disclosure.

FIG. 3 depicts an example of MTAP using another electronic device to augment transports available to it, in accordance with various aspects and principles of the present disclosure.

FIG. 3A depicts an example of MTAP using another MTAP to augment transport mechanisms available to it, in accordance with various aspects and principles of the present disclosure.

FIG. 4 depicts examples of the device discovery procedure using MTAP, in accordance with various aspects and principles of this disclosure.

FIG. 5 depicts an example of process of data transfer between two electronic devices through MTAP, in accordance with various aspects and principles of the present disclosure.

FIG. 5A depicts an example of message exchange during a process of data transfer between two electronic devices through MTAP, in accordance with various aspects and principles of the present disclosure.

FIG. 6 shows an example of communication between a passive device and an active device through MTAP, in accordance with various aspects and principles of the present disclosure.

### DETAILED DESCRIPTION

In the description that follows, like components have been given the same reference numerals, regardless of whether they are shown in different embodiments. To illustrate an embodiment(s) of the present disclosure in a clear and concise manner, the drawings may not necessarily be to scale and certain features may be shown in somewhat schematic form. Features that are described and/or illustrated with respect to one embodiment may be used in the same way or in a similar way in one or more other embodiments and/or in combination with or instead of the features of the other embodiments.

In accordance with various embodiments of this disclosure, what is disclosed is a transport mechanism-agnostic communication system. The system may include a plurality of electronic devices, each configured with at least one transport mechanism, and at least one electronic device being configured with two or more heterogeneous transport mechanisms. The at least one electronic device is capable of communicating with each of the plurality of electronic devices and may include a processor, in communication with a memory, configured to execute instructions to translate and route data packets received from a first electronic device over a first transport to a second electronic device over a second heterogeneous transport, wherein the first electronic device can communicate with the second electronic device via the at least one electronic device.

In another embodiment, a method for transport mechanism-agnostic communication between a first electronic device and a second electronic device is described. The method may include connecting the first electronic device and the second electronic device, each enabled with at least one transport with a third electronic device enabled with two or more heterogeneous transports such that each of the first electronic device and the second electronic device can communicate with the third electronic device directly or indirectly over at least one transport, and translating and routing data packets received by the third electronic device from the first electronic device over a first transport to the second electronic device over the second transport.

Typically, communication between electronic devices in a network may include signal exchange or data transfer between two or more electronic devices such as, for example, control signals, short messaging service (point-to-point, cell broadcast or application-to-person) signals, multimedia messaging service signals, encoded audio signals, paging signals, voice over internet protocol (VoIP), peer-to-peer file uploading, peer-to-peer file downloading, video-over-wireless communication, TCP IP, and the like, or any combination thereof.

A network may include fixed devices, mobile devices, or a combination of both, that are connected by wired links, wireless links, or a combination of both. In various embodiments, wireless links may include, without limitation, WiFi, WiFi Direct, WiMax, Bluetooth, WWAN, WiGig, ZigBee, WiDi, one way radio, two way radio, any mobile broadband communication system (for example UMTS, CDMA, HIPERMAN, ETSI, BRAN, GSM/GPRS, EDGE, HSPA, LTE, etc.), and the like. Various devices within the network may have, for example, one or more radios, transmitters, receivers, transceivers, chipsets, amplifiers, filters, control logic circuits, network interface cards, antennas, antenna arrays, and the like.

In various embodiments, the network may include fixed devices having wired communication or wireless communication capabilities such as, for example, a wireless access point (AP), base station or node B, router, switch, hub, gateway, or any combination thereof. A fixed device may have generalized equipment set providing connectivity and/or information to another wireless device, such as one or more mobile devices. A fixed device may be, for example, a kitchen appliance (e.g. a refrigerator), a television, a temperature controller, household devices, a desktop PC, a router, a switch, a modem,

In various embodiments, the network may include electronic devices such as, for example, a computer, server, workstation, notebook computer, handheld computer, telephone, cellular telephone, personal digital assistant (PDA), combination cellular telephone and PDA, and so forth. In some embodiments, the fixed devices or the mobile devices may be capable of running software applications.

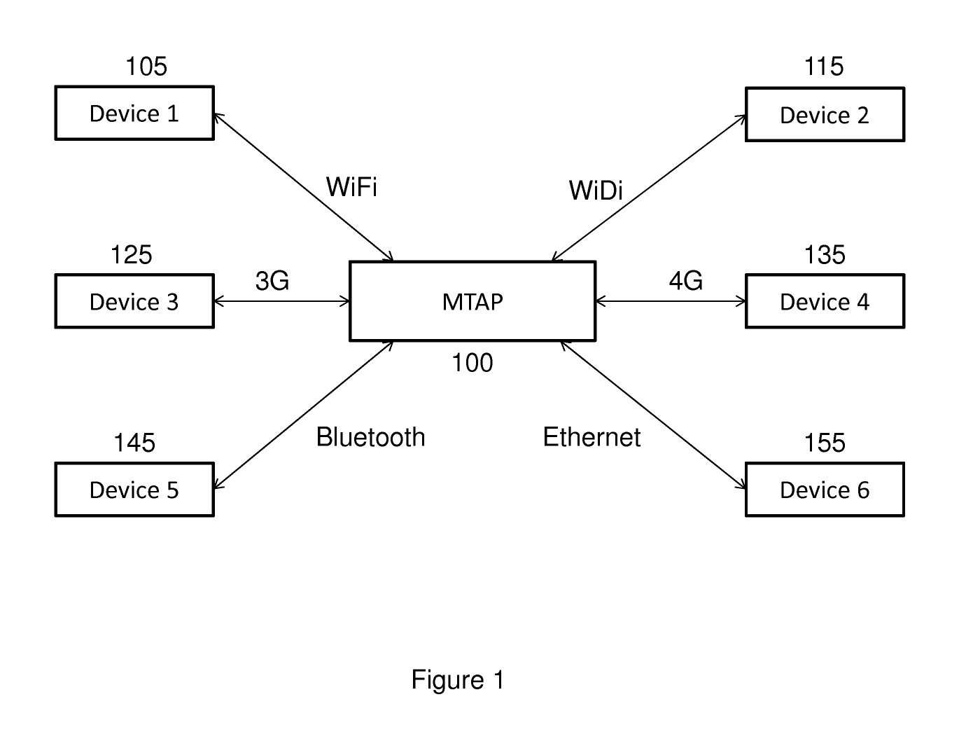

FIG. 1 depicts an example of a multi-transport access point (MTAP) 100 in accordance with various aspects and principles of the present disclosure. MTAP 100 is configured to communicate with diverse electronic devices 105, 115, 125, 135, 145, and 155 that may communicate using various, if not heterogeneous, transport mechanisms. As such, MTAP 100 is configured as a transport mechanism-agnostic communication device allowing seamless communication between diverse electronic devices.

With this said, MTAP 100, in various embodiments, may be an electronic device capable of wired or wireless communication using multiple communication methods. For example, MTAP 100 may be capable of communicating with the various other electronic devices (105, 115, 125, 135, 145, and 155) using Ethernet, WiFi, WiFi Direct, Bluetooth, WiMax, WWAN, WiGig, ZigBee, any mobile broadband communication system (for example UMTS, CDMA, HIPERMAN, ETSI, BRAN, GSM/GPRS, EDGE, HSPA, LTE, etc.), one-way radio, two-way radio, and the like. MTAP 100 may include, for example, one or more radios, transmitters, receivers, transceivers, chipsets, amplifiers, filters, control logic circuits, network interface cards, antennas, antenna arrays, and the like. In some embodiments MTAP 100 may be a dedicated device. In other embodiments, MTAP 100 may be soft-implemented on a generic electronic device such as, for example, a computer, server, workstation, notebook computer, handheld computer, tablet, telephone, cellular telephone, personal digital assistant (PDA), combination cellular telephone and PDA, and so forth.

MTAP 100, in various embodiments, may run protocol stack implementations for the various transport mechanisms desired to be supported, depending on the transport mechanisms supported by the devices intended to be operated with MTAP 100. In the example depicted in FIG. 1, electronic device 105 may support only WiFi communication and would run the protocol stack implementation at least for WiFi. On the other hand, MTAP 100, supporting, for example, WiFi, WiFi Direct, Bluetooth, 3G, 4G, WiDi and Ethernet transports may be configured to run protocol stack implementations for all of the supported transport media. This enables MTAP 100 to communicate with various devices supporting all of these transport media.

In addition, the electronic devices that intend to communicate through MTAP 100 may also run middleware applications that are capable of, inter alia, enabling device discovery, managing connections and supporting various services. The software running on MTAP 100 is capable of receiving data through one protocol stack and passing it down to another protocol stack. The software running on MTAP 100 is further capable of managing connections and routing data between various devices connected to it. Thus, MTAP 100 enables transport mechanism-agnostic communication between various electronic devices enabled with heterogeneous transport mechanisms when the various electronic devices are connected to MTAP 100.

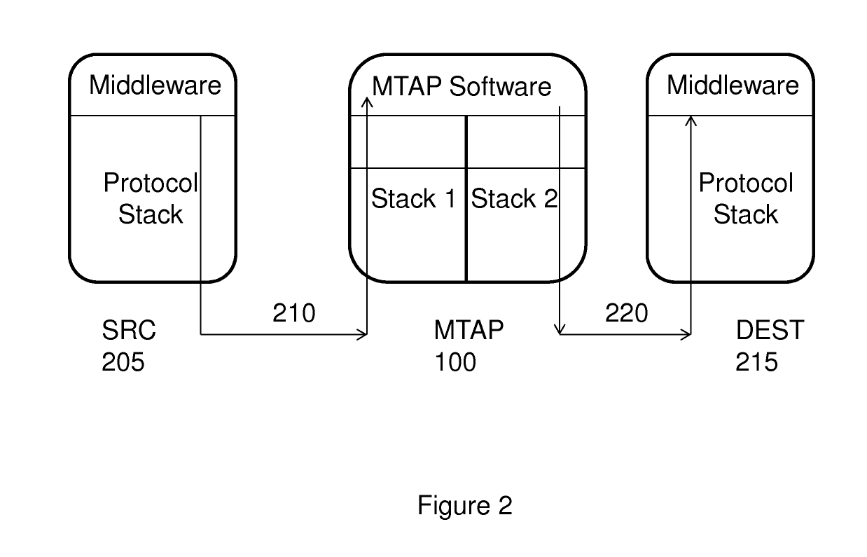

FIG. 2 depicts management of data transport between two devices via MTAP, in accordance with various aspects and principles of the present disclosure. As depicted, source device (SRC) 205 is in communication with destination device (DEST) 215 through MTAP 100. Data from an application running on SRC 205 is sent to MTAP 100 through the protocol stack, running on SRC 205, for transport medium 210 connecting SRC 205 and MTAP 100. Once received at MTAP 100, the software running on MTAP 100 passes it down to another protocol stack for transport medium 220 connecting MTAP 100 to DEST 215 and routes it through transport medium 220 to DEST 215. The protocol stack running on DEST 215, then, passes the data up to the application running on DEST 215.

Electronic devices may communicate with each other to provide services including, but not limited to, file transfer, media (images, audio and/or video) streaming, raw data transfer, exchange of control signals, VoIP signals, paging signals and so on. In various embodiments, service discovery may be integrated with device discovery. Each electronic device that can communicate with or through MTAP 100 runs the middleware which provides means for end-to-end device and service discovery. MTAP 100 keeps track of the list of services supported and/or offered by various electronic devices connected to it. Table 1 shows an example the device list maintained by MTAP 100. Various device specific parameters in the device list may include, for example, IsReal (to identify whether an interface is real or virtual), IsPassive (to identify whether a device is passive or active), and so forth.

TABLE 1
Device list maintained by MTAP

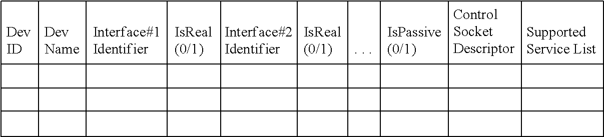

Referring, again, to FIG. 1, the middleware may allow electronic device 105 to discover electronic devices 115, 125, 135, 145 and 155 and vice-versa. The software running on MTAP 100, with the help of various protocol stack implementations converts WiFi data packets coming from electronic device 105 to, for example, UMTS packets for communicating with electronic device 125. Similarly, MTAP 100 allows electronic device 105 having only a WiFi radio can send data to electronic device 145 (for example) only capable of communicating using Bluetooth. In such a case, MTAP 100 can receive the data from the first electronic device 105 over WiFi and transmit the data to electronic device 145 using Bluetooth. The software running on MTAP 100 converts the WiFi data packets to Bluetooth data packets.

One skilled in the art will appreciate that MTAP 100 may be able to communicate with multiple devices at the same time. For example, MTAP 100 may receive data from electronic device 105 and transmit it to electronic devices 115, 135 and 145 all at the same time using WiDi, 4G and Bluetooth transports, or receive data from electronic devices 115 and 135 and transmit it to electronic devices 125, 105 and 145. Accordingly, various combinations of one-to-many, many-to-one and many-to-many communications are conceived.

In some embodiments, MTAP 100 may not be able to act as a host (convergence point) for a particular transport. In such embodiments, MTAP 100 may act as a client to another device which can work as the host for that transport. This augments the capabilities of MTAP 100.

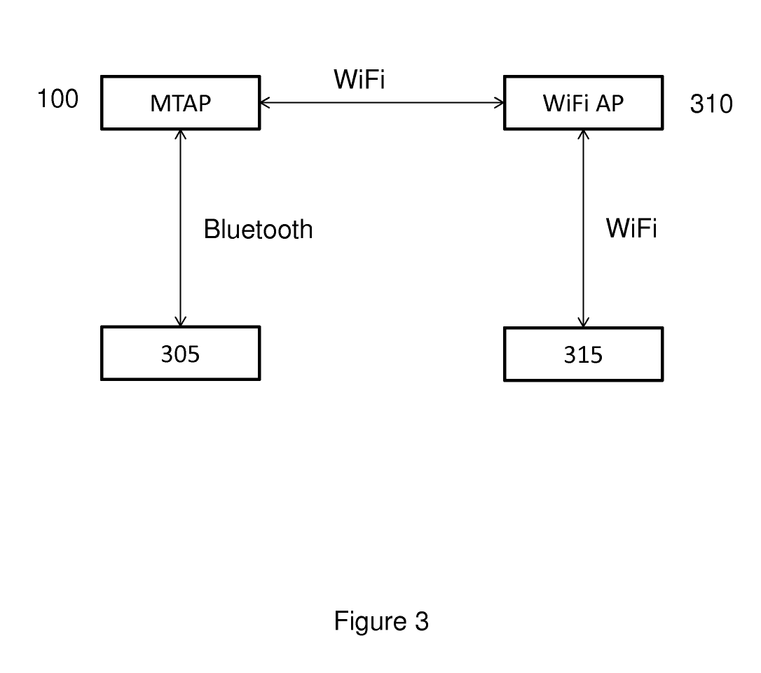

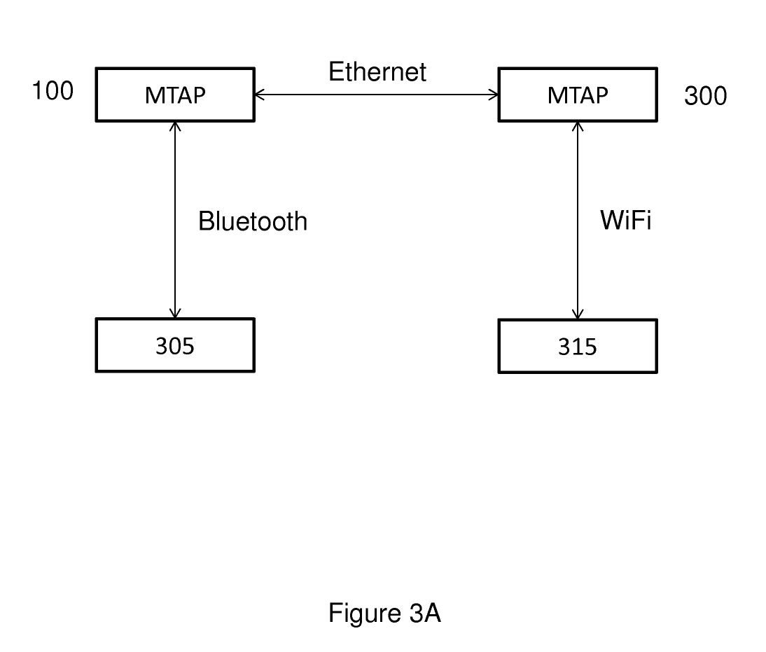

FIG. 3 depicts an example of MTAP using another electronic device to augment transport mechanisms available to it in accordance with various aspects and principles of the present disclosure. As depicted in FIG. 3, in the event that MTAP 100 is not itself capable of acting as a host (convergence point), for example, for Wifi transport, it acts a client to WiFi access point 310 to route a data transfer between electronic device 305 having, for example, only Bluetooth transport and another device 315 having, for example, only WiFi transport through WiFi access point 310. One skilled in the art will appreciate that such augmentation is possible for any transport including, but not limited to, Ethernet, WiFi, WiFi Direct, Bluetooth, WiMax, WiGig, WWAN, ZigBee, WiDi, 3G, 4G, 2-way radio, 1-way radio, and so forth.

In some embodiments, MTAP 100 may not have all transports available to it. In such embodiments, another MTAP which supports a different set of transports can be used to augment the capabilities of MTAP 100, provided that they share at least one common transport between them. Hence, by chaining MTAPs, the number of transport mechanisms supported by the system can be extended, and a variety of electronic devices equipped with different transport mechanisms can be supported.

FIG. 3A depicts an example of MTAP using another MTAP to augment transport mechanisms available to it in accordance with various aspects and principles of the present disclosure. As depicted in FIG. 3A, in the event that MTAP 100 is not itself capable of communicating over WiFi, MTAP 100 may communicate with another MTAP 300 using, for example, an Ethernet connection, to route a data transfer between electronic device 305 having, for example, only Bluetooth transport and another device 315 having, for example, only WiFI transport. A skilled artisan will be able to conceive such augmentation is possible for any transport including, but not limited to, Ethernet, WiFi, WiFi Direct, Bluetooth, WiMax, WiGig, WWAN, ZigBee, WiDi, 3G, 4G, 2-way radio, 1-way radio, and so forth.

Referring, again, to FIG. 1, MTAP 100 allows multiple electronic devices (105, 115, 125, 135, 145, and 155) to communicate with each other regardless of the specific transport medium supported by individual devices. MTAP 100 supports end-to-end device discovery and a mechanism for establishment of trust between devices. As such, once MTAP 100 is connected to various electronic devices (in case of wired transports) or is within range of various radios (in case of wireless transports), electronic device 105 is discoverable to electronic devices 115, 125, 135, 145 and 155 and vice-versa.

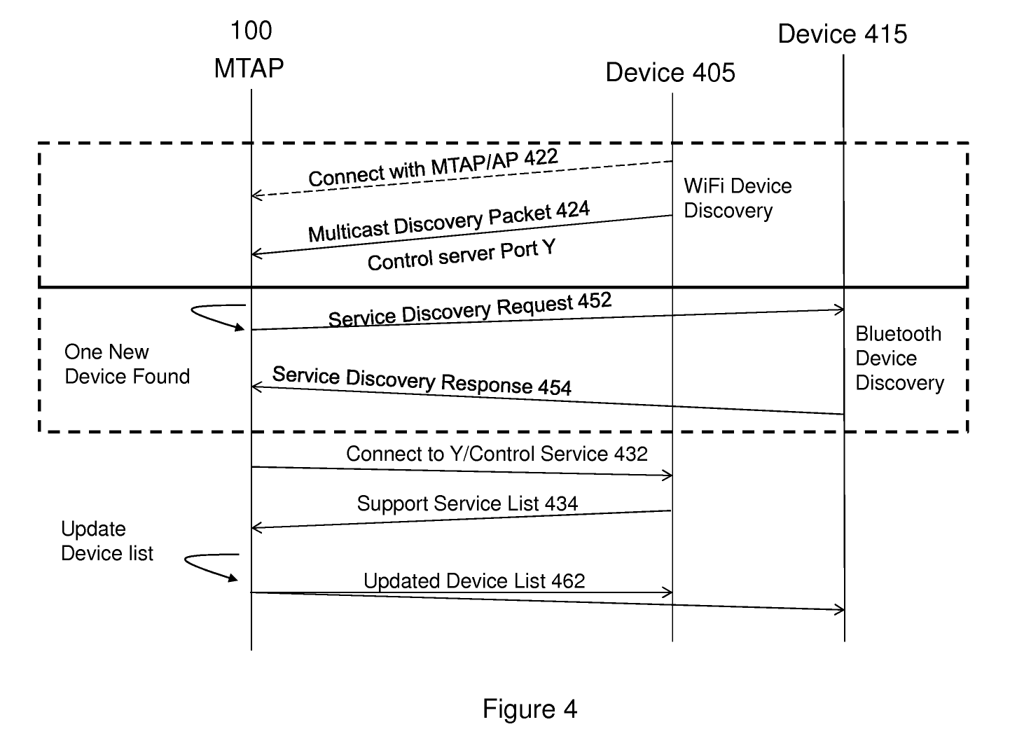

FIG. 4 depicts examples of the device discovery procedure using the MTAP in accordance with various aspects and principles of this disclosure. Device 405 is capable of communicating with MTAP 100 using WiFi only and Device 415 is capable of communicating with MTAP 100 using Bluetooth only.

An electronic device supporting WiFi communication, for example, as depicted in FIG. 4, device 405 first associates and connects to MTAP 100 over WiFi as evidenced by transactional message 422. Upon successful connection with MTAP 100, the middleware running on device 405 sends out a multicast discovery request message 424 containing the control server information that includes that port number (say, e.g. Y) at which a WiFi connection is available. A control module on the MTAP software running on MTAP 100 then attempts to connect to the control server of device 405 via port Y as evidenced by transactional message 432. Device 405 sends an available service list to MTAP 100 upon successful connection between MTAP 100 and device 405 via transactional message 434.

Alternately, an electronic device supporting a peer-to-peer transport such as, for example, Bluetooth, as depicted in FIG. 4, MTAP 100 may periodically scan for new devices. Upon detecting the presence of a new device, device 415, MTAP 100 may send out a service discovery request message 452 (e.g. in case of Bluetooth, this would be a standard SDP request). In response to service discovery request message 452, device 415 sends a service discovery response message 454 which includes, among other things, the control service channel information (say, e.g. Y). If device 415 is not already paired with MTAP 100, device 415 initiates (not shown) pairing with MTAP 100. MTAP 100 then connects with device 415 via control service on channel Y. Device 415 then sends the available service list to MTAP 100 upon successful connection between MTAP 100 and device 415.

Similarly, in case of an electronic device supporting peer-to-peer transport such as, for example, WiFi Direct (case not shown in figure), MTAP 100 may act as a group owner or a client or both depending on the group owner intent of the devices connected to it. MTAP 100 advertises high group owner intent so as to become a group owner. However, MTAP 100 may not advertise group owner intent so high as to prevent group owner-only devices from connecting to MTAP 100. Depending on which role MTAP 100 assumes, it may discover devices differently. For example, if MTAP 100 is in peer-to-peer device role, it may periodically send device discovery request frames which advertise MTAP service (similar to the Bluetooth case). On discovering a WiFi Direct device in range, it will perform service discovery to identify support for the middleware. If MTAP 100 is in peer-to-peer client role, it may turn on the device discoverability and may listen for and accept any incoming connections. On the other hand, if MTAP 100 is in peer-to-peer group owner role, it may periodically send a Notice of Absence for listening on other channels and band for beacons from new WiFi Direct devices. Once a device is successfully connected to MTAP 100, MTAP 100 obtains available service list from the device.

In various embodiments, MTAP 100 maintains a device list as depicted in Table 1. Likewise, upon receipt of service information, MTAP 100 updates the device list from Table 1 and sends this updated list to all devices connected to it. This allows every device connected to MTAP 100 to discover the presence of other devices connected to MTAP 100 and also discover the services supported by each of those devices. This information may be made transparent to a user of MTAP 100 or any of the devices connected to MTAP 100.

Such a device list may be indexed using unique device IDs. For each ID, the associated device may be given a name derived from the advertisement data. If the device name is not available, a generic class of the device may be mentioned. Additionally, the device list may include an array of interface identifier for each device connected to MTAP 100 such as, for example, a BD address for Bluetooth devices or an IP address for Ethernet, WiFi or WiFi Direct devices. Further, each interface identifier may be associated with a bit containing information as to whether the interface is real or virtual. Every device connected to MTAP 100 has at least one real interface. If, for a device, a transport (interface) supported by MTAP 100 is not available to the device, MTAP 100 may assign a unique virtual address for such an interface. All interfaces available on connected devices may be represented in this manner in the device list.

Similarly, another bit containing information as to whether a device is passive or active may be associated with the device ID. The table may further contain, for each connected device, a descriptor for the control socket which is established at the time of device discovery as well as a listing of all the services supported by a particular device.

A passive device, as described herein, is a device where an end-user is not be able to configure or add software to what already exists on the device. As such, passive devices may not run the middleware for communicating with MTAP 100. Examples of passive devices include, but are not limited to, a Bluetooth headset, a key fob, a temperature controller, a kitchen appliance, a WiFi printer, a WiDi adapter, and so forth. For a passive device, the software running on MTAP 100 may include in the service list a known service provided by that passive device, which would have been discovered by MTAP 100 using the service discovery procedure intrinsic to the transport supported by the passive device.

It is to be noted that the device discovery process described herein is illustrative and a skilled artisan will appreciate that the device discovery process described herein is not restricted to WiFi, WiFi Direct or Bluetooth transports. The skilled artisan would easily be able to extend this process to other types of transports.

In various embodiments, the middleware may require user intervention so as to establish security and trust between various communicating devices connected to MTAP 100. For example, when the middleware on a client device detects the presence of MTAP 100 based on device discovery, it may prompt the user of the client device before establishing connection with MTAP 100. If the user accepts the connection, the client device and MTAP 100 may add one another to their respective trusted device lists such that any future connection between this particular MTAP and the client device can happen without any further user intervention. Particular transport protocols used by MTAP 100 and the client device may provide further security for any data communicated between the two.

Table 2 depicts an example of a connection map table for a routing entry maintained by MTAP 100 once two electronic devices supporting disparate transports are connected to each other through MTAP 100. Such routing entry allows data from one of the electronic devices connected to MTAP 100 to be forwarded directly to the second electronic device and vice-versa, for a particular service being used, while converting the transport protocols between the two. The initiating and responding socket descriptors are used for receiving data from one device and forwarding to the other. The routing entry may be cleared off once the transfer of data or communication between the two electronic devices is completed. It will be appreciated that Table 2 is illustrative and non-limiting. One skilled in the art will be able to conceive a connection map table including other parameters.

TABLE 2
Connection map for routing entry.

| | | | | | |
|---|---|---|---|---|---|
| Connec- | Device | Device | End-to-End | Initiating | Responding |
| tion ID | 1 ID | 2 ID | Service | socket | socket |
| | | | | descriptor | descriptor |

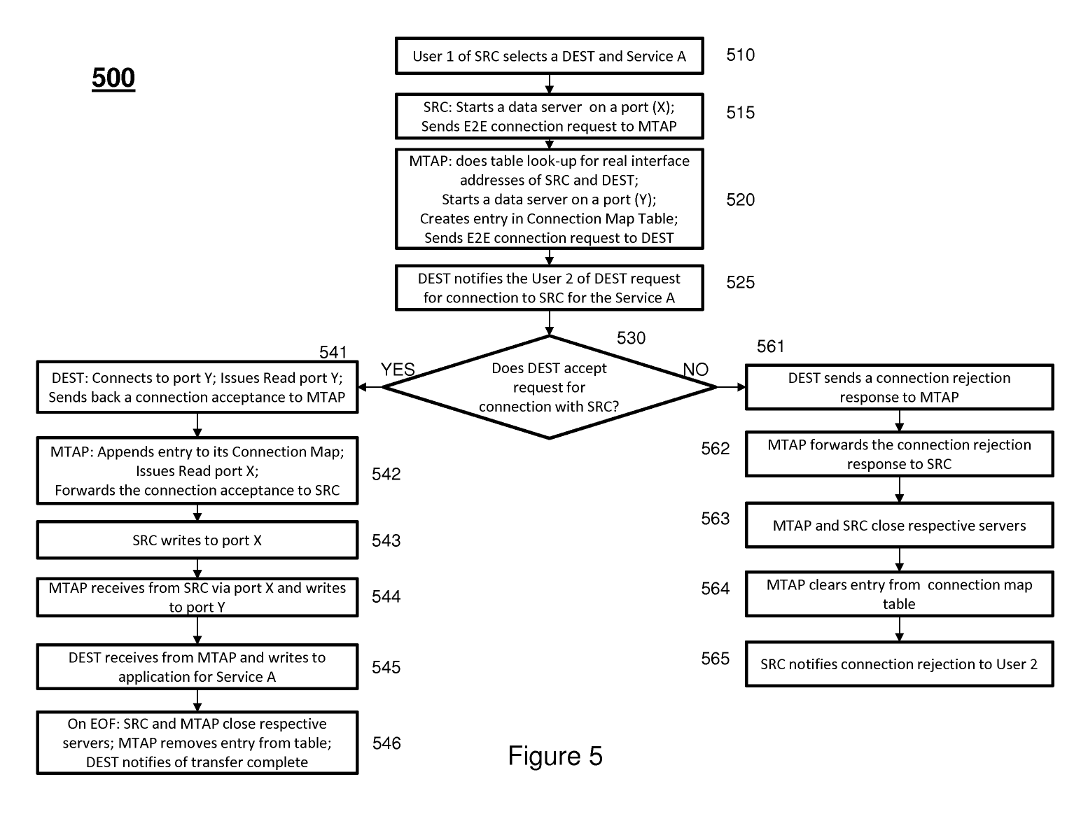

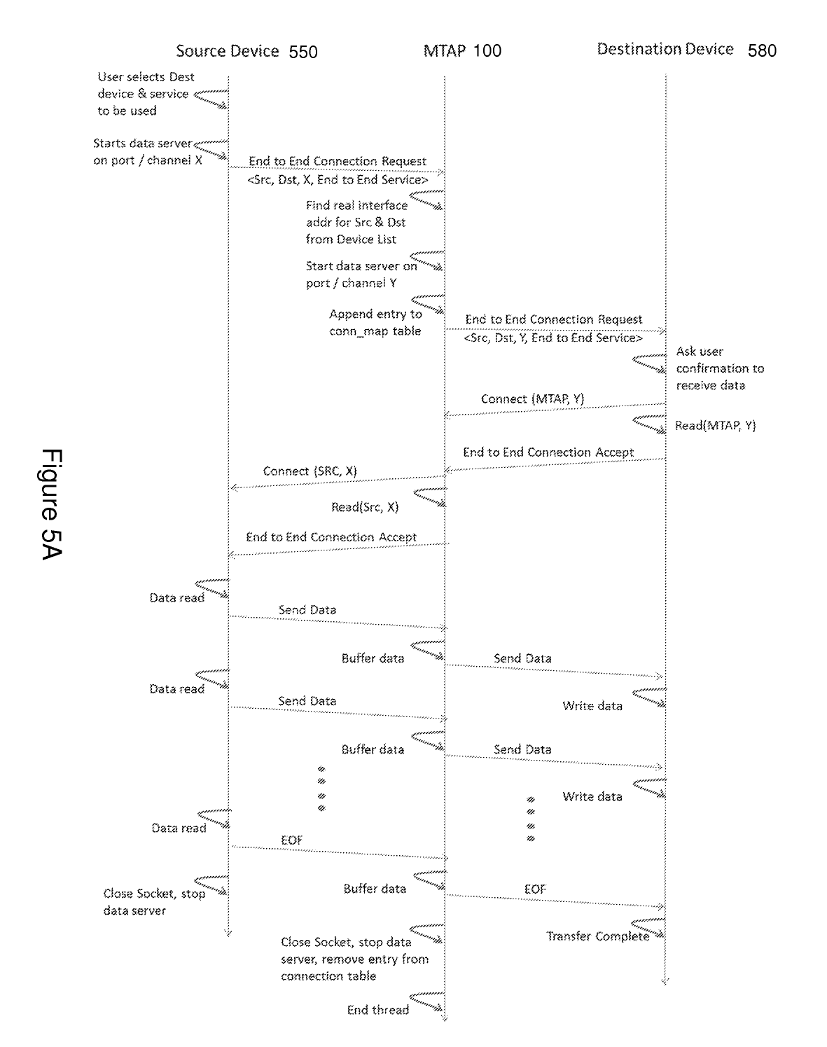

FIG. 5 depicts an example of process 500 of data transfer between two electronic devices through MTAP 100, in accordance with various aspects and principles of the present disclosure. Once MTAP 100 establishes connections with various electronic devices and the electronic devices connected to MTAP 100 become discoverable, at block 510, a user (User 1) of a source device (SRC) selects a destination device (DEST) and a service (Service A) supported by DEST. Following this input by User 1, at block 515, SRC starts a data server on a port (port X) available on SRC and send an end-to-end (E2E) connection request to MTAP 100 which includes the device ID for SRC, device ID for DEST, desired E2E service supported by DEST (e.g. file sharing) and information about port X on which the data server of SRC is open.

Upon receipt of an E2E connection request from SRC, at block 520, the MTAP looks up its device list for the real interface addresses of SRC and DEST, starts a data server on port (port Y) available on MTAP 100 and forwards the E2E connection request to DEST which includes the device ID for SRC, the device ID for DEST, desired E2E service supported by DEST (e.g. file sharing) and information about port Y on which the data server of MTAP 100 is open. MTAP 100 also appends an incomplete entry to the connection map table, containing the device IDs, the service requested and the initiating socket descriptor.

Once DEST receives the E2E connection request from MTAP 100, at block 525, the DEST notifies the user (e.g. User 2) DEST of the E2E connection request asking for permission for SRC to use the desired service (Service A, e.g file sharing). If User 2 accepts the connection request (YES), at step 541, DEST issues a Read command over port Y on which the data server for MTAP 100 is open and sends back a connection acceptance to the MTAP. At block 542, MTAP 100 completes the entry in its connection map table with the responding socket descriptor, issues a Read command over port X on which the data server for SRC is open and forwards the connection acceptance to SRC.

When SRC receives the connection acceptance, at block 543, SRC writes out to MTAP 100 via port X. At block 544, MTAP 100 receives the data from SRC via port X and writes out to DEST via port Y. In turn, at block 545, DEST receives the data from MTAP 100 via port Y and sends it to the designated application of Service A. When SRC encounters an end-of-file (EOF) for the data to be communicated to MTAP 100, at block 546, SRC closes its data server and port, following which MTAP 100 closes its data server and port Y and then, DEST notifies MTAP 100 of completion of data which then forwards it to SRC. MTAP 100 then removes the corresponding entry from the connection map table.

If, at block 530, User 2 declines the connection request (NO), at block 561, DEST sends out a connection rejection response to MTAP 100. MTAP 100, at block 562, forwards this connection rejection response to SRC. At block 563, MTAP 100 and SRC close their data servers and ports Y and X respectively. At block 564, MTAP 100 clears the corresponding connection map table entry and at block 565, SRC notifies its user (User 1) regarding the connection rejection.

Alternatively, the process can be understood using FIG. 5A which depicts an example message exchange during the process of data transfer between a source device (SRC) 550 and a destination device (DEST) 580 through MTAP 100, in accordance with various aspects and principles of the present disclosure.

When a user with SRC 550 selects a device from the list of DESTs and a service to connect to from the list of services supported by the chosen DEST 580 (e.g., file sharing, where the user intends to send a file from SRC 550 to DEST 580), SRC 550 does the following: (a) starts a data server (e.g., on port/channel ‘X’); and (b) sends an E2E connection request to MTAP 100 (on the control connection) with parameters including, but not limited to, the following: (i) SRC Device ID, (ii) DEST Device ID, (iii) E2E Service desired (e.g., file sharing), and (iv) Port/Channel ‘X’.

Upon receiving the E2E connection request, MTAP 100 does the following: (a) looks up its Available Devices table for the Real interface addresses of SRC 550 and DEST 580; (b) starts a data server (e.g., on port/channel ‘Y’); and (c) sends an E2E connection request to the DEST 580 (on the control connection) with parameters including, but not limited to, the following: (i) SRC Device ID, (ii) DEST Device ID, (iii) E2E Service desired (e.g., file sharing), and (iv) Port/Channel ‘Y’.

Upon receiving the E2E connection request, DEST 580 does the following: (a) displays a pop-up to the user asking for permission for SRC 550 to use the requested service (e.g., file sharing); and assuming that the user of DEST 580 accepts the request; (b) issues Read(Y) on the MTAP 100 and blocks; and (c) sends back a connection acceptance response to the MTAP 100.

Subsequently, upon receiving the E2E connection acceptance response, MTAP 100 does the following: (a) appends an entry to its Connection Map table; (b) issues Read(X) on SRC 550 and blocks; and (c) forwards the connection acceptance response to the SRC 550.

Upon receiving the E2E connection acceptance response, SRC 550 keeps writing out the file on the socket it had opened on its port/channel ‘X’.

MTAP 100, on receiving the bytes, keeps writing out (forwarding) the bytes on the socket it had opened on its port/channel ‘Y’.

DEST 580, on receiving the bytes, keeps writing out the bytes to the requested application (e.g., to a file when SRC 550 has requested file sharing application).

When SRC 550 encounters end-of-file (EOF), it closes down the server. MTAP 100 does the same. When DEST 580 encounters EOF, it notifies of transfer complete.

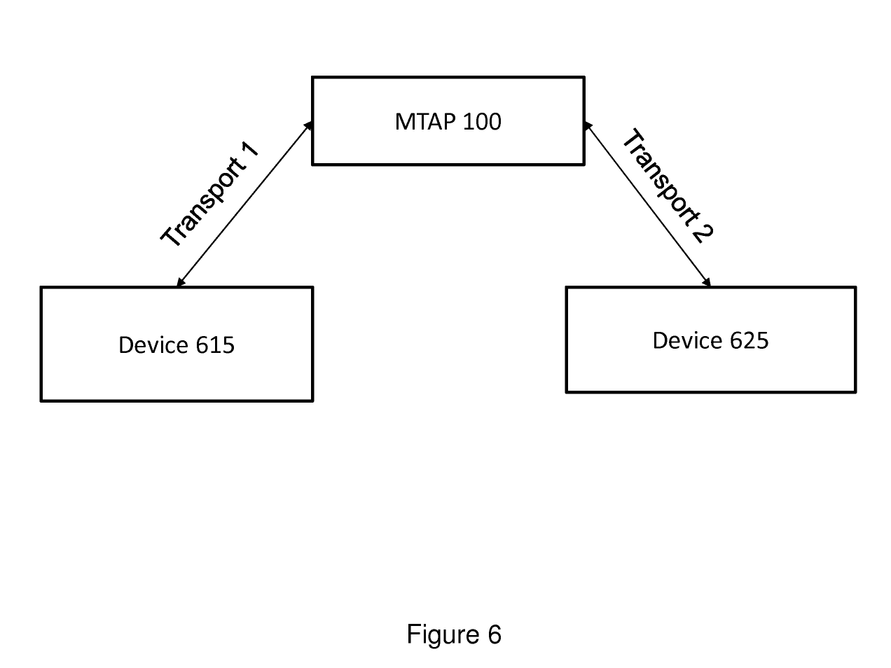

In some embodiments, one or more of the devices connected to MTAP 100 may be passive devices. FIG. 6 shows an example of communication between a passive device and an active device through MTAP 100 in accordance with various aspects and principles of the present disclosure.

In the example of FIG. 6, a user of device 615 (e.g. a Bluetooth headset) which is capable of communicating only via transport 1 (e.g Bluetooth) wishes to access data (e.g. music) from device 625 (e.g. a desktop PC) which is capable of communicating only via transport 2 (e.g. Ethernet) which is distinct (and incompatible) from transport 1. As such, the two devices 615 and 625 may only communicate via MTAP 100.

Once the two devices 615 and 625 are in range and connected to MTAP 100, they are discoverable to each other. MTAP 100, in its device list, contains information of both the devices 615 and 625. Based on this information, MTAP 100 concludes that device 615 is a passive device and does not run the middleware. Thus, when device 625 requests connection to device 615 through the control channel between MTAP 100 and device 625, MTAP 100 uses its implementation of the protocol stack for transport 1 to establish connection with device 615. Once the handshake between MTAP 100 and device 615 completes, device 615 goes into “streaming state” (e.g. for a Bluetooth headset) for receiving data from MTAP 100. At this point, MTAP 100 notifies device 625 via the middleware on device 625 to relay the data desired by the user of device 615. The middleware of device 625 may then use any application suitable to relay the requested data to MTAP 100, which in turn relays the requested data to device 615 using the suitable protocol stack present on MTAP 100.

In embodiments where device 615 wishes to send a command (e.g. Pause, Play, Next Track, Previous Track, etc. e.g. for a Bluetooth headset), MTAP 100 receives the commands from device 615 via transport 1 and routes the information to the middleware of device 625 using a suitable protocol defined by the application being used by device 625 for relaying the requested data. Device 625 then takes the appropriate action. A skilled artisan will be able to conceive communication between various pairs of passive and active devices.

These and other features and characteristics, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of claims. As used in the specification and in the claims, the singular form of “a”, “an”, and “the” include plural referents unless the context clearly dictates otherwise.

Embodiments within the scope of the present disclosure may further include computer-readable media for carrying or having computer-executable instructions or data structures stored thereon. Such computer-readable media can be any available media that can be accessed by a general purpose or a special purpose computer. Such computer-readable media may include, but are not limited to, RAM, ROM, EEPROM, CD-ROM, or other optical disk storage, magnetic disk storage, or other magnetic storage devices, or any other medium which can be used to carry or store desired program code means in the form of computer-executable instructions or data structures. When information is transferred or provided over a network or another communications connection (either hardwired, wireless or a combination thereof) to a computer, the computer properly views the connection as a computer-readable medium. Thus, any such connection is properly termed as computer-readable medium. Combinations of the above should also be included within the scope of the computer-readable media.

Computer-executable instructions include, but are not limited to, instructions and data which cause a general purpose computer, a special purpose computer, or a special purpose processing device to perform a certain function or a group of functions. Computer-executable instructions also include program modules that are executed by computers in stand-alone or network environments. Generally, program modules include routines, programs, objects, components, data structures, and the like, that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Having thus described the basic concepts, it will be rather apparent to those skilled in the art after reading this detailed disclosure that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure. In addition, the term “logic” is representative of hardware, firmware, software (or any combination thereof) to perform one or more functions. For instance, examples of “hardware” include, but are not limited to, an integrated circuit, a finite state machine, or even combinatorial logic. The integrated circuit may take the form of a processor such as a microprocessor, an application specific integrated circuit, a digital signal processor, a micro-controller, or the like.

Furthermore, the recited order of processing elements or sequences, or the use of numbers, letters, or other designations therefore, is not intended to limit the claimed processes and methods to any order except as can be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, as the following claims reflect, inventive embodiments lie in less than all features of a single foregoing disclosed embodiment. Thus, the claims following the detailed description are hereby expressly incorporated into this detailed description.

### Examples

The following examples highlight non-limiting characteristics and attributes of the various and principles of the present disclosure:

Example 1 is a transport mechanism-agnostic communication system. The system may include a plurality of electronic devices, each configured with at least one transport mechanism and at least one electronic device being configured with two or more heterogeneous transport mechanisms, the at least one electronic device is capable of communicating with each of the plurality of electronic devices. The at least one electronic device includes a processor, in communication with a memory, configured to execute instructions to translate and route data packets received from a first electronic device over a first transport to a second electronic device over a second heterogeneous transport, wherein the first electronic device can communicate with the second electronic device via the at least one electronic device.

Example 2 is the system of example 1, wherein the at least one electronic device enables the plurality of electronic devices to discover one another upon establishment of connection between the plurality of electronic devices and the at least one electronic device.

Example 3 is the system of any one of examples 1 and 2, wherein the at least one electronic device enables the plurality of electronic devices to discover services supported by each of the plurality of electronic devices upon establishment of connection of the plurality of electronic devices with the at least one electronic device.

Example 4 is the system of any one of examples 1-3, wherein one or more of the plurality of electronic devices comprises a passive electronic device.

Example 5 is the system of any one of examples 1-4, wherein the at least one electronic device is enabled with two or more of transports including Ethernet, WiFi, WiFi Direct, WiMax, Bluetooth, WiGig, ZigBee, WiDi, CDMA, GSM, LIE, one way radio, and two way radio.

Example 6 is the system of any one of examples 1-5, wherein the plurality of electronic devices are enabled with at least one transport including Ethernet, WiFi, WiFi Direct, WiMax, Bluetooth, WiGig, ZigBee, WiDi, CDMA, GSM, LIE, one way radio, and two way radio.

Example 7 is the system of any one of examples 1-6, wherein the at least one electronic device routes a data packet to a second electronic device enabled with a second transport via a first electronic device enabled with a first transport and a second transport, and wherein the first electronic device communicates with the second electronic device over the second transport and the at least one electronic device communicates with the first electronic device over the first transport.

Example 8 is the system of any one of examples 1-7, wherein the at least one electronic device maintains, in a memory, a list comprising the plurality of electronic devices connected to the at least one electronic device and services offered by the plurality of electronic devices.

Example 9 is the system of example 8, wherein the list further comprises real and virtual transport identifiers for transport mechanisms supported by the at least one electronic device.

Example 10 is the system of any one of examples 1-9, wherein the first electronic device and the second electronic device establish mutual trust using explicit user confirmation.

Example 11 is a method for transport mechanism-agnostic communication between a first electronic device and a second electronic device. The method includes connecting the first electronic device and the second electronic device, each enabled with at least one transport with a third electronic device enabled with two or more heterogeneous transports such that each of the first electronic device and the second electronic device can communicate with the third electronic device directly or indirectly over at least one transport; and translating and routing data packets received by the third electronic device from the first electronic device over a first transport to the second electronic device over the second transport.

Example 12 is the method of example 11, wherein the third electronic device enables the first electronic device and the second electronic device to discover each other upon establishment of connection with the third electronic device.

Example 13 is the method of any one of examples 11 and 12, wherein the third electronic device enables the first electronic device to discover services supported by the second electronic device and vice-versa upon establishment of connection with the third electronic device.

Example 14 is the method of any one of examples 11-13, wherein the third electronic device is enabled with two or more transports including Ethernet, WiFi, WiFi Direct, WiMax, Bluetooth, WiGig, ZigBee, WiDi, CDMA, GSM, LTE, one way radio, and two way radio.

Example 15 is the method of any one of examples 11-14, wherein the first electronic device and the second electronic device are enabled with at least one transport including Ethernet, WiFi, WiFi Direct, WiMax, Bluetooth, WiGig, ZigBee, WiDi, CDMA, GSM, LTE, one way radio, and two way radio.

Example 16 is the method of any one of examples 11-15, further comprising maintaining, in a memory of the third electronic device, a list comprising electronic devices and services offered by the electronic devices connected to the third electronic device.

Example 17 is the method of example 16, wherein the list further comprises real and virtual transport identifiers for transport mechanisms supported by the third electronic device.

Example 18 is the method of any one of examples 11-17, further comprising establishing mutual trust between the first electronic device and the second electronic device using explicit user confirmation.

Example 19 is an electronic device comprising means for performing a method of any one of examples 11-18.

Example 20 is an electronic device comprising a processor, in communication with a memory, for executing instructions to perform a method of any one of examples 11-18.

Example 21 is a system comprising means for performing a method of any one of examples 11-18.

Example 22 is a system comprising at least one electronic device comprising a processor, in communication with a memory, for executing instructions to perform a method of any one of examples 11-18.

Example 23 is a computer-readable medium comprising computer-readable code physically embodied thereon which, when executed by a processor, causes the processor to perform a method of any one of examples 11-18.

Example 24 is a computer-readable medium comprising computer-readable instructions to implement, when executed, the method of any one of examples 11-18.

Example 25 is a computer program product comprising a computer-readable medium having computer program logic recorded thereon arranged to execute the method of any one of examples 11-18.

Example 26 is the system of example 1, wherein the at least one electronic device enables the plurality of electronic devices to discover one another upon establishment of connection between the plurality of electronic devices and the at least one electronic device.

Example 27 is the system of example 1, wherein the at least one electronic device enables the plurality of electronic devices to discover services supported by each of the plurality of electronic devices upon establishment of connection of the plurality of electronic devices with the at least one electronic device.

Example 28 is the system of example 1, wherein one or more of the plurality of electronic devices comprises a passive electronic device.

Example 29 is the system of example 1, wherein the at least one electronic device is enabled with two or more of transports including Ethernet, WiFi, WiFi Direct, WiMax, Bluetooth, WiGig, ZigBee, WiDi, CDMA, GSM, LTE, one way radio, and two way radio.

Example 30 is the system of example 1, wherein the plurality of electronic devices are enabled with at least one transport including Ethernet, WiFi, WiFi Direct, WiMax, Bluetooth, WiGig, ZigBee, WiDi, CDMA, GSM, LTE, one way radio, and two way radio.

Example 31 is the system of example 1, wherein the at least one electronic device routes a data packet to a second electronic device enabled with a second transport via a first electronic device enabled with a first transport and a second transport, and wherein the first electronic device communicates with the second electronic device over the second transport and the at least one electronic device communicates with the first electronic device over the first transport.

Example 32 is the system of example 1, wherein the at least one electronic device maintains, in a memory, a list comprising the plurality of electronic devices connected to the at least one electronic device and services offered by the plurality of electronic devices.

Example 33 is the system of example 32, wherein the list further comprises real and virtual transport identifiers for transport mechanisms supported by the at least one electronic device.

Example 34 is the system of example 1, wherein the first electronic device and the second electronic device establish mutual trust using explicit user confirmation.

Example 35 is the method of example 11, wherein the third electronic device enables the first electronic device and the second electronic device to discover each other upon establishment of connection with the third electronic device.

Example 36 is the method of example 11, wherein the third electronic device enables the first electronic device to discover services supported by the second electronic device and vice-versa upon establishment of connection with the third electronic device.

Example 37 is the method of example 11, wherein the third electronic device is enabled with two or more transports including Ethernet, WiFi, WiFi Direct, WiMax, Bluetooth, WiGig, ZigBee, WiDi, CDMA, GSM, LTE, one way radio, and two way radio.

Example 38 is the method of example 11, wherein the first electronic device and the second electronic device are enabled with at least one transport including Ethernet, WiFi, WiFi Direct, WiMax, Bluetooth, WiGig, ZigBee, WiDi, CDMA, GSM, LTE, one way radio, and two way radio.

Example 39 is the method of example 11, further comprising maintaining, in a memory of the third electronic device, a list comprising electronic devices and services offered by the electronic devices connected to the third electronic device.

Example 40 is the method of example 39, wherein the list further comprises real and virtual transport identifiers for transport mechanisms supported by the third electronic device.

Example 41 is the method of example 11, further comprising establishing mutual trust between the first electronic device and the second electronic device using explicit user confirmation.

Example 42 is a computer-readable medium comprising computer-readable code physically embodied thereon which, when executed by a processor, causes the processor to perform a method of example 11.

1. A transport mechanism-agnostic communication system comprising:
a plurality of electronic devices, each configured with at least one transport mechanism; and
at least one electronic device being configured with two or more heterogeneous transport mechanisms, the at least one electronic device is capable of communicating with each of the plurality of electronic devices, the at least one electronic device comprising:
a processor, in communication with a memory, configured to execute instructions to translate and route data packets received from a first electronic device over a first transport to a second electronic device over a second heterogeneous transport,
wherein the first electronic device can communicate with the second electronic device via the at least one electronic device.

2. The system of claim 1, wherein the at least one electronic device enables the plurality of electronic devices to discover one another upon establishment of connection between the plurality of electronic devices and the at least one electronic device.

3. The system of claim 1, wherein the at least one electronic device enables the plurality of electronic devices to discover services supported by each of the plurality of electronic devices upon establishment of connection of the plurality of electronic devices with the at least one electronic device.

4. The system of claim 1, wherein one or more of the plurality of electronic devices comprises a passive electronic device.

5. The system of claim 1, wherein the at least one electronic device is enabled with two or more of transports including Ethernet, WiFi, WiFi Direct, WiMax, Bluetooth, WiGig, ZigBee, WiDi, CDMA, GSM, LTE, one way radio, and two way radio.

6. The system of claim 1, wherein the plurality of electronic devices are enabled with at least one transport including Ethernet, WiFi, WiFi Direct, WiMax, Bluetooth, WiGig, ZigBee, WiDi, CDMA, GSM, LTE, one way radio, and two way radio.

7. The system of claim 1, wherein the at least one electronic device routes a data packet to a second electronic device enabled with a second transport via a first electronic device enabled with a first transport and a second transport, and wherein the first electronic device communicates with the second electronic device over the second transport and the at least one electronic device communicates with the first electronic device over the first transport.

8. The system of claim 1, wherein the at least one electronic device maintains, in a memory, a list comprising the plurality of electronic devices connected to the at least one electronic device and services offered by the plurality of electronic devices.

9. The system of claim 8, wherein the list further comprises real and virtual transport identifiers for transport mechanisms supported by the at least one electronic device.

10. The system of claim 1, wherein the first electronic device and the second electronic device establish mutual trust using explicit user confirmation.

11. A method for transport mechanism-agnostic communication between a first electronic device and a second electronic device, the method comprising:
connecting the first electronic device and the second electronic device, each enabled with at least one transport with a third electronic device enabled with two or more heterogeneous transports such that each of the first electronic device and the second electronic device can communicate with the third electronic device directly or indirectly over at least one transport; and
translating and routing data packets received by the third electronic device from the first electronic device over a first transport to the second electronic device over the second transport.

12. The method of claim 11, wherein the third electronic device enables the first electronic device and the second electronic device to discover each other upon establishment of connection with the third electronic device.

13. The method of claim 11, wherein the third electronic device enables the first electronic device to discover services supported by the second electronic device and vice-versa upon establishment of connection with the third electronic device.

14. The method of claim 11, wherein the third electronic device is enabled with two or more transports including Ethernet, WiFi, WiFi Direct, WiMax, Bluetooth, WiGig, ZigBee, WiDi, CDMA, GSM, LTE, one way radio, and two way radio.

15. The method of claim 11, wherein the first electronic device and the second electronic device are enabled with at least one transport including Ethernet, WiFi, WiFi Direct, WiMax, Bluetooth, WiGig, ZigBee, WiDi, CDMA, GSM, LTE, one way radio, and two way radio.

16. The method of claim 11, further comprising maintaining, in a memory of the third electronic device, a list comprising electronic devices and services offered by the electronic devices connected to the third electronic device.

17. The method of claim 16, wherein the list further comprises real and virtual transport identifiers for transport mechanisms supported by the third electronic device.

18. The method of claim 11, further comprising establishing mutual trust between the first electronic device and the second electronic device using explicit user confirmation.

19-22. (canceled)

23. A computer-readable medium comprising computer-readable code physically embodied thereon which, when executed by a processor, causes the processor to perform a method of claim 11.

24-25. (canceled)
